(19) United States
(12) Patent Application Publication
(10) Pub. No.: US 2010/0079385 A1
(43) Pub. Date: Apr. 1, 2010

(54) METHOD FOR CALIBRATING AN INTERACTIVE INPUT SYSTEM AND INTERACTIVE INPUT SYSTEM EXECUTING THE CALIBRATION METHOD

(75) Inventors: DAVID E. HOLMGREN, Calgary (CA); George Clarke, Calgary (CA); Roberto A.L. Sirotich, Calgary (CA); Edward Tse, Calgary (CA); Yunqui Rachel Wang, Calgary (CA); Joe Wright, Strathmore (CA); Grant McGibney, Calgary (CA)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(73) Assignee: SMART TECHNOLOGIES ULC, Calgary (CA)

(21) Appl. No.: 12/240,963

(22) Filed: Sep. 29, 2008

(51) Int. Cl. G06F 3/041

(52) U.S. Cl. 345/173

(57) ABSTRACT

A method of calibrating an interactive input system comprises receiving images of a calibration video presented on a touch panel of the interactive input system. A calibration image is created based on the received images, and features are located in the calibration image. A transformation between the touch panel and the received images is determined based on the located features and corresponding features in the calibration video.

### FIELD OF THE INVENTION

The present invention relates generally to interactive input systems and in particular, to a method for calibrating an interactive input system and an interactive input system executing the calibration method.

### BACKGROUND OF THE INVENTION

Interactive input systems that allow users to inject input (eg. digital ink, mouse events etc.) into an application program using an active pointer (eg. a pointer that emits light, sound or other signal), a passive pointer (eg. a finger, cylinder or other suitable object) or other suitable input device such as for example, a mouse or trackball, are known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Multi-touch interactive input systems that receive and process input from multiple pointers using machine vision are also known. One such type of multi-touch interactive input system exploits the well-known optical phenomenon of frustrated total internal reflection (FTIR). According to the general principles of FTIR, the total internal reflection (TIR) of light traveling through an optical waveguide is frustrated when an object such as a pointer touches the waveguide surface, due to a change in the index of refraction of the waveguide, causing some light to escape from the touch point. In a multi-touch interactive input system, the machine vision system captures images including the point(s) of escaped light, and processes the images to identify the position of the pointers on the waveguide surface based on the point(s) of escaped light for use as input to application programs. One example of an FTIR multi-touch interactive input system is disclosed in United States Patent Application Publication No. 2008/0029691 to Han.

In order to accurately register the location of touch points detected in the captured images with corresponding points on the display surface such that a user's touch points correspond to expected positions on the display surface, a calibration method is performed. Typically during calibration, a known calibration image is projected onto the display surface. The projected image is captured, and features are extracted from the captured image. The locations of the extracted features in the captured image are determined, and a mapping between the determined locations and the locations of the features in the known calibration image is performed. Based on the mapping of the feature locations, a general transformation between any point on the display surface and the captured image is defined thereby to complete the calibration. Based on the calibration, any touch point detected in a captured image may be transformed from camera coordinates to display coordinates.

FTIR systems display visible light images on a display surface, while detecting touches using infrared light. IR light is generally filtered from the displayed images in order to reduce interference with touch detection. However, when performing calibration, an infrared image of a filtered, visible light calibration image captured using the infrared imaging device has a very low signal-to-noise ratio. As a result, feature extraction from the calibration image is extremely challenging.

It is therefore an object of the present invention to provide a novel method for calibrating an interactive input system, and an interactive input system executing the calibration method.

### SUMMARY OF THE INVENTION

Accordingly, in one aspect there is provided a method of calibrating an interactive input system, comprising:

receiving images of a calibration video presented on a touch panel of the interactive input system;

creating a calibration image based on the received images;

locating features in the calibration image; and

determining a transformation between the touch panel and the received images based on the located features and corresponding features in the calibration video.

According to another aspect, there is provided an interactive input system comprising a touch panel and processing structure executing a calibration method, said calibration method determining a transformation between the touch panel and an imaging plane based on known features in a calibration video presented on the touch panel and features located in a calibration image created based on received images of the calibration video.

According to another aspect, there is provided a computer readable medium embodying a computer program for calibrating an interactive input device, the computer program comprising:

computer program code receiving images of a calibration video presented on a touch panel of the interactive input system;

computer program code creating a calibration image based on the received images;

computer program code locating features in the calibration image; and

computer program code determining a transformation between the touch panel and the received images based on the located features and corresponding features in the calibration video.

According to yet another aspect, there is provided a method for determining one or more touch points in a captured image of a touch panel in an interactive input system, comprising:

creating a similarity image based on the captured image and an image of the touch panel without any touch points;

creating a thresholded image by thresholding the similarity image based on an adaptive threshold;

identifying one or more touch points as areas in the thresholded image; and

refining the bounds of the one or more touch points based on pixel intensities in corresponding areas in the similarity image.

According to yet another aspect, there is provided an interactive input system comprising a touch panel and processing structure executing a touch point determination method, said touch point determination method determining one or more touch points in a captured image of the touch panel as areas identified in a thresholded similarity image refined using pixel intensities in corresponding areas in the similarity image.

According to still yet another aspect, there is provided a computer readable medium embodying a computer program for determining one or more touch points in a captured image of a touch panel in an interactive input system, the computer program comprising:

computer program code creating a similarity image based on the captured image and an image of the touch panel without any touch points;

computer program code creating a thresholded image by thresholding the similarity image based on an adaptive threshold;

computer program code identifying one or more touch points as areas in the thresholded image; and

computer program code refining the bounds of the one or more touch points based on pixel intensities in corresponding areas in the similarity image.

### BRIEF DESCRIPTION OF THE DRAWINGS

Embodiments will now be described more fully with reference to the accompanying drawings in which:

FIG. 1 is a perspective view of an interactive input system;

FIG. 2a is a side sectional view of the interactive input system of FIG. 1;

FIG. 2b is a sectional view of a table top and touch panel forming part of the interactive input system of FIG. 1.

FIG. 3 is a flowchart showing calibration steps undertaken to identify a transformation between the display surface and the image plane;

FIG. 4 is a flowchart showing image processing steps undertaken to identify touch points in captured images;

FIG. 5 is a single image of a calibration video captured by an imaging device;

FIG. 6 is a graph showing the various pixel intensities at a selected location in captured images of the calibration video;

FIGS. 7a to 7d are images showing the effects of anisotropic diffusion for smoothing a mean difference image while preserving edges to remove noise;

FIG. 8 is a diagram illustrating the radial lens distortion of the lens of an imaging device;

FIG. 9 is a distortion-corrected image of the edge-preserved difference image;

FIG. 10 is an edge image based on the distortion-corrected image;

FIG. 11 is a diagram illustrating the mapping of a line in an image plane to a point in the Radon plane;

FIG. 12 is an image of the Radon transform of the edge image;

FIG. 13 is an image showing the lines identified as peaks in the Radon transform image overlaid on the distortion-corrected image to show the correspondence with the checkerboard pattern;

FIG. 14 is an image showing the intersection points of the lines identified in FIG. 13;

FIG. 15 is a diagram illustrating the mapping of a point in the image plane to a point in the display plane;

FIG. 16 is a diagram showing the fit of the transformation between the intersection points in the image plane and known intersection points in the display plane;

FIGS. 17a to 17d are images processed during determining touch points in a received input image; and

FIG. 18 is a graph showing the pixel intensity selected for adaptive thresholding during image processing for determining touch points in a received input image.

### DETAILED DESCRIPTION OF THE EMBODIMENTS

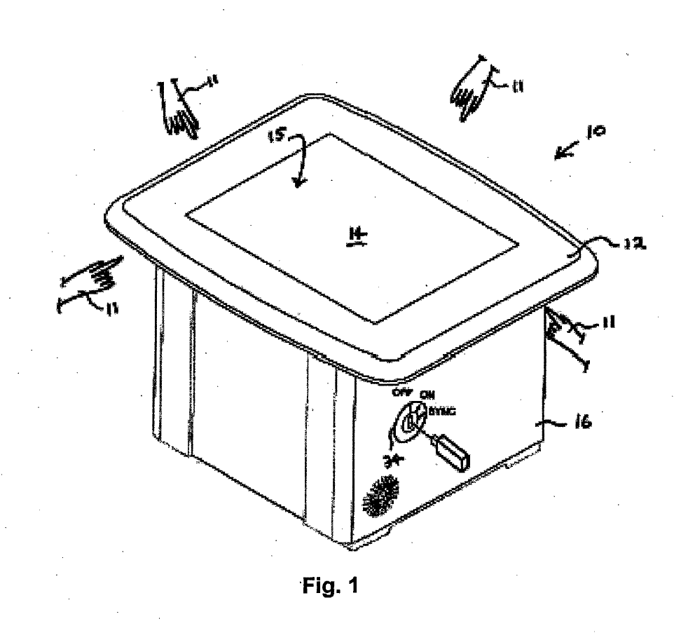

Turning now to FIG. 1, a perspective diagram of an interactive input system in the form of a touch table is shown and is generally identified by reference numeral 10. Touch table 10 comprises a table top 12 mounted atop a cabinet 16. In this embodiment, cabinet 16 sits atop wheels 18 that enable the touch table 10 to be easily moved from place to place in a classroom environment. Integrated into table top 12 is a coordinate input device in the form of a frustrated total internal refraction (FTIR) based touch panel 14 that enables detection and tracking of one or more pointers 11, such as fingers, pens, hands, cylinders, or other objects, applied thereto.

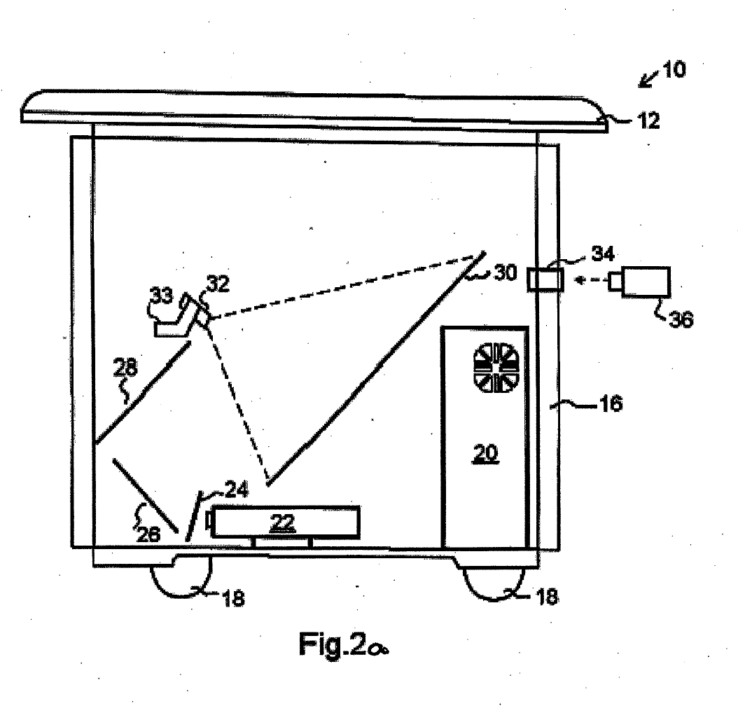

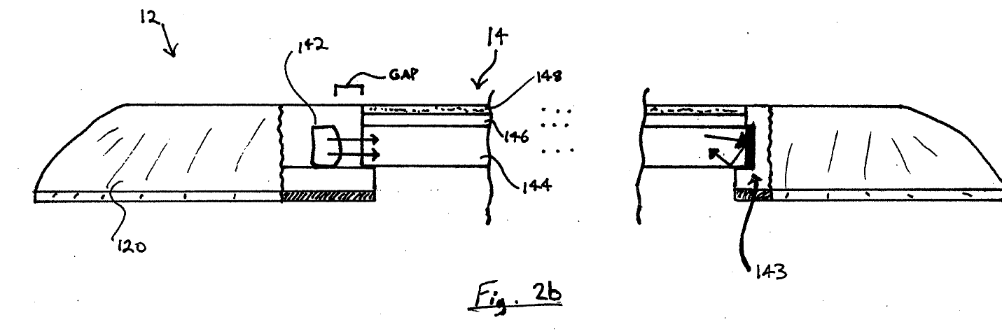

Cabinet 16 supports the table top 12 and touch panel 14, and houses a processing structure 20 (see FIG. 2) executing a host application and one or more application programs, with which the touch panel 14 communicates. Image data generated by the processing structure 20 is displayed on the touch panel 14 allowing a user to interact with the displayed image via pointer contacts on the display surface 15 of the touch panel 14. The processing structure 20 interprets pointer contacts as input to the running application program and updates the image data accordingly so that the image displayed on the display surface 15 reflects the pointer activity. In this manner, the touch panel 14 and processing structure 20 form a closed loop allowing pointer interactions with the touch panel 14 to be recorded as handwriting or drawing or used to control execution of the application program.

The processing structure 20 in this embodiment is a general purpose computing device in the form of a computer. The computer comprises for example, a processing unit, system memory (volatile and/or non-volatile memory), other non-removable or removable memory (a hard disk drive, RAM, ROM, EEPROM, CD-ROM, DVD, flash memory etc.) and a system bus coupling the various computer components to the processing unit.

The processing structure 20 runs a host software application/operating system which, during execution, provides a graphical user interface comprising a canvas page or palette. In this embodiment, the graphical user interface is presented on the touch panel 14, such that freeform or handwritten ink objects and other objects can be input and manipulated via pointer interaction with the display surface 15 of the touch panel 14.

FIG. 2 is a side elevation cutaway view of the touch table 10. The cabinet 16 supporting table top 12 and touch panel 14 also houses a horizontally-oriented projector 22, an infrared (IR) filter 24, and mirrors 26, 28 and 30. An imaging device 32 in the form of an infrared-detecting camera is mounted on a bracket 33 adjacent mirror 28. The system of mirrors 26, 28 and 30 functions to “fold” the images projected by projector 22 within cabinet 16 along the light path without unduly sacrificing image size. The overall touch table 10 dimensions can thereby be made compact.

The imaging device 32 is aimed at mirror 30 and thus sees a reflection of the display surface 15 in order to mitigate the appearance of hotspot noise in captured images that typically must be dealt with in systems having imaging devices that are directed at the display surface itself. Imaging device 32 is positioned within the cabinet 16 by the bracket 33 so that it does not interfere with the light path of the projected image.

During operation of the touch table 10, processing structure 20 outputs video data to projector 22 which, in turn, projects images through the IR filter 24 onto the first mirror 26. The projected images, now with IR light having been substantially filtered out, are reflected by the first mirror 26 onto the second mirror 28. Second mirror 28 in turn reflects the images to the third mirror 30. The third mirror 30 reflects the projected video images onto the display (bottom) surface of the touch panel 14. The video images projected on the bottom surface of the touch panel 14 are viewable through the touch panel 14 from above. The system of three mirrors 26, 28, 30 configured as shown provides a compact path along which the projected image can be channeled to the display surface. Projector 22 is oriented horizontally in order to preserve projector bulb life, as commonly-available projectors are typically designed for horizontal placement.

An external data port/switch, in this embodiment a Universal Serial Bus (USB) port/switch 34, extends from the interior of the cabinet 16 through the cabinet wall to the exterior of the touch table 10 providing access for insertion and removal of a USB key 36, as well as switching of functions.

The USB port/switch 34, projector 22, and imaging device 32 are each connected to and managed by the processing structure 20. A power supply (not shown) supplies electrical power to the electrical components of the touch table 10. The power supply may be an external unit or, for example, a universal power supply within the cabinet 16 for improving portability of the touch table 10. The cabinet 16 fully encloses its contents in order to restrict the levels of ambient visible and infrared light entering the cabinet 16 thereby to facilitate satisfactory signal to noise performance. However, provision is made for the flow of air into and out of the cabinet 16 for managing the heat generated by the various components housed inside the cabinet 16, as described in U.S. patent application Ser. No. ______ (ATTORNEY DOCKET No. 6355-260) entitled “TOUCH PANEL FOR INTERACTIVE INPUT SYSTEM AND INTERACTIVE INPUT SYSTEM EMPLOYING THE TOUCH PANEL” to Sirotich et al. filed on even date herewith and assigned to the assignee of the subject application, the content of which is incorporated herein by reference in its entirety.

As set out above, the touch panel 14 of touch table 10 operates based on the principles of frustrated total internal reflection (FTIR), as described in further detail in the above-mentioned U.S. patent application Ser. No. ______ (ATTORNEY DOCKET 6355-260). FIG. 2b is a sectional view of the table top 12 and touch panel 14 for the touch table 10 shown in FIG. 1. Table top 12 comprises a frame 120 supporting the touch panel 14. In this embodiment, frame 120 is composed of plastic. Touch panel 14 comprises an optical waveguide layer 144 that, according to this embodiment, is a sheet of acrylic. A resilient diffusion layer 146 lies against the optical waveguide layer 144. The diffusion layer 146 substantially reflects the IR light escaping the optical waveguide layer 144 down into the cabinet 16, and diffuses visible light being projected onto it in order to display the projected image. Overlying the resilient diffusion layer 146 on the opposite side of the optical waveguide layer 144 is a clear, protective layer 148 having a smooth touch surface. While the touch panel 14 may function without the protective layer 148, the protective layer 148 permits use of the touch panel 14 without undue discoloration, snagging or creasing of the underlying diffusion layer 146, and without undue wear on users' fingers. Furthermore, the protective layer 148 provides abrasion, scratch and chemical resistance to the overall touch panel 14, as is useful for panel longevity. The protective layer 148, diffusion layer 146, and optical waveguide layer 144 are clamped together at their edges as a unit and mounted within the table top 12. Over time, prolonged use may wear one or more of the layers. As desired, the edges of the layers may be unclamped in order to inexpensively provide replacements for the worn layers. It will be understood that the layers may be kept together in other ways, such as by use of one or more of adhesives, friction fit, screws, nails, or other fastening methods. A bank of infrared light emitting diodes (LEDs) 142 is positioned along at least one side surface of the optical waveguide layer 144 (into the page in FIG. 2b). Each LED 142 emits infrared light into the optical waveguide layer 144. Bonded to the other side surfaces of the optical waveguide layer 144 is reflective tape 143 to reflect light back into the optical waveguide layer 144 thereby saturating the optical waveguide layer 144 with infrared illumination. The IR light reaching other side surfaces is generally reflected entirely back into the optical waveguide layer 144 by the reflective tape 143 at the other side surfaces.

In general, when a user contacts the display surface 15 with a pointer 11, the pressure of the pointer 11 against the touch panel 14 “frustrates” the TIR at the touch point causing IR light saturating an optical waveguide layer 144 in the touch panel 14 to escape at the touch point. The escaping IR light reflects off of the pointer 11 and scatters locally downward to reach the third mirror 30. This occurs for each pointer 11 as it contacts the display surface 15 at a respective touch point.

As each touch point is moved along the display surface 15, the escape of IR light tracks the touch point movement. During touch point movement or upon removal of the touch point (more precisely, a contact area), the escape of IR light from the optical waveguide layer 144 once again ceases. As such, IR light escapes from the optical waveguide layer 144 of the touch panel 14 only at touch point location(s).

Imaging device 32 captures two-dimensional, IR video images of the third mirror 30. IR light having been filtered from the images projected by projector 22, in combination with the cabinet 16 substantially keeping out ambient light, ensures that the background of the images captured by imaging device 32 is substantially black. When the display surface 15 of the touch panel 14 is contacted by one or more pointers as described above, the images captured by IR camera 32 comprise one or more bright points corresponding to respective touch points. The processing structure 20 receives the captured images and performs image processing to detect the coordinates and characteristics of the one or more bright points in the captured image. The detected coordinates are then mapped to display coordinates and interpreted as ink or mouse events by application programs running on the processing structure 20.

The transformation for mapping detected image coordinates to display coordinates is determined by calibration. For the purpose of calibration, a calibration video is prepared that includes multiple frames including a black-white checkerboard pattern and multiple frames including an inverse (i.e., white-black) checkerboard pattern of the same size. The calibration video data is provided to projector 22, which presents frames of the calibration video on the display surface 15 via mirrors 26, 28 and 30. Imaging device 32 directed at mirror 30 captures images of the calibration video.

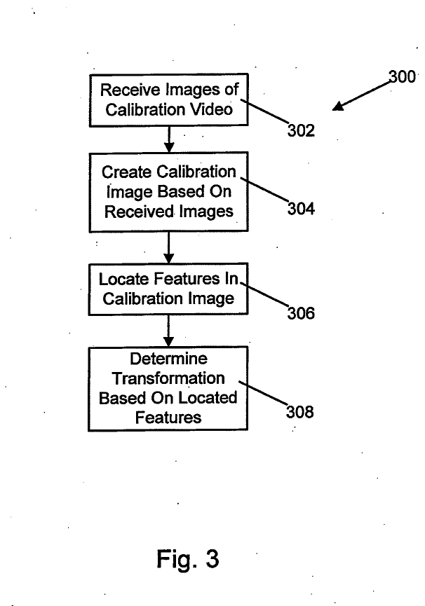

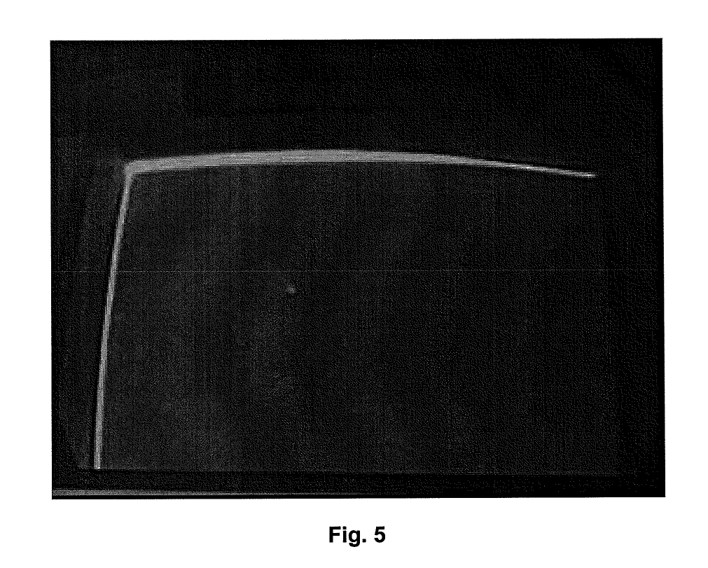

FIG. 3 is a flowchart 300 showing steps performed to determine the transformation from image coordinates to display coordinates using the calibration video. First, the captured images of the calibration video are received (step 302). FIG. 5 is a single captured image of the calibration video. The signal to noise ratio in the image of FIG. 5 is very low, as would be expected. It is difficult to glean the checkerboard pattern for calibration from this single image.

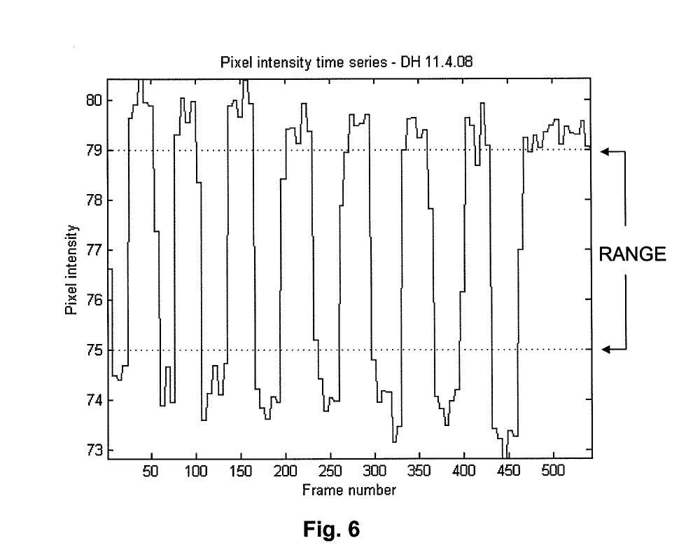

However, based on several received images of the calibration video, a calibration image with a defined checkerboard pattern is created (step 304). During creation of the calibration image, a mean checkerboard image I_{c} is created based on received images of the checkerboard pattern, and a mean inverse checkerboard image I_{ic} is created based on received images of the inverse checkerboard pattern. In order to distinguish received images corresponding to the checkerboard pattern from received images corresponding to the inverse checkerboard pattern, pixel intensity of a pixel or across a cluster of pixels at a selected location in the received images is monitored. A range of pixel intensities is defined, having an upper intensity threshold and a lower intensity threshold. Those received images having, at the selected location, a pixel intensity that is above the upper intensity threshold are considered to be images corresponding to the checkerboard pattern. Those received images having, at the selected location, a pixel intensity that is below the lower intensity threshold are considered to be images corresponding to the inverse checkerboard pattern. Those received images having, at the selected location, a pixel intensity that is within the defined range of pixel intensities, are discarded. In the graph of FIG. 6, the horizontal axis represents, for a received set of images captured of the calibration video, the received image number, and the vertical axis represents the pixel intensity at the selected pixel location for each of the received images. The upper and lower intensity thresholds defining the range are also shown in FIG. 6.

The mean checkerboard image IC is formed by setting each of its pixels as the mean intensity of corresponding pixels in each of the received images corresponding to the checkerboard pattern. Likewise, the mean inverse checkerboard image L_{ci} is formed by setting each of its pixels as the mean intensity of corresponding pixels in each of the received images corresponding to the inverse checkerboard pattern.

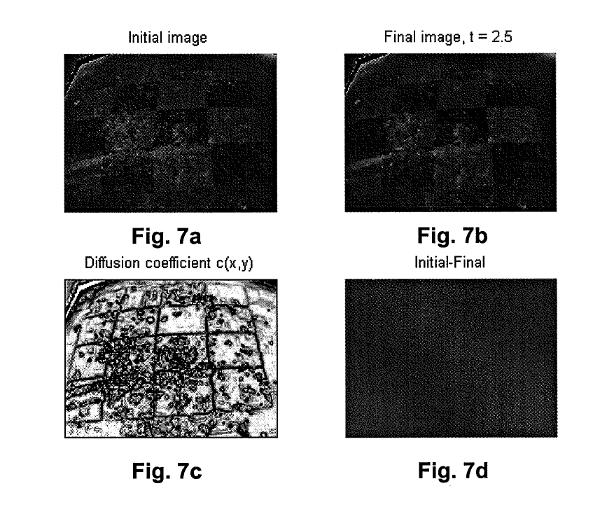

The mean checkerboard image I_{c} and the mean inverse checkerboard image I_{ci} are then scaled to the same intensity range [0,1]. A mean difference, or “grid” image d, as shown in FIG. 7a, is then created using the mean checkerboard and mean inverse checkerboard images I_{c} and I_{ic}, according to Equation 1, below:

d=I_{c}−I_{ic} (1)

The mean grid image is then smoothed using an edge preserving smoothing procedure in order to remove noise while preserving prominent edges in the mean grid image. In this embodiment, the smoothing, edge-preserving procedure is an anisotropic diffusion, as set out in the publication by Perona et al. entitled “Scale-Space And Edge Detection Using Anisotropic Diffusion”; 1990, IEEE TPAMI, vol. 12, no. 7, 629-639, the content of which is incorporated herein by reference in its entirety.

FIGS. 7b to 7d show the effects of anisotropic diffusion on the mean grid image shown in FIG. 7a. FIG. 7b shows the mean grid image after having undergone ten (10) iterations of the anisotropic diffusion procedure, and FIG. 7d shows an image representing the difference between the mean grid image in FIG. 7a and the resultant smoothed, edge-preserved mean grid image in 7b, thereby illustrating the mean grid image after non-edge noise has been removed. FIG. 7c shows an image of the diffusion coefficient c(x,y) and thereby illustrates where smoothing is effectively limited in order to preserve edges. It can be seen from FIG. 7c that smoothing is limited at the grid lines in the edge image.

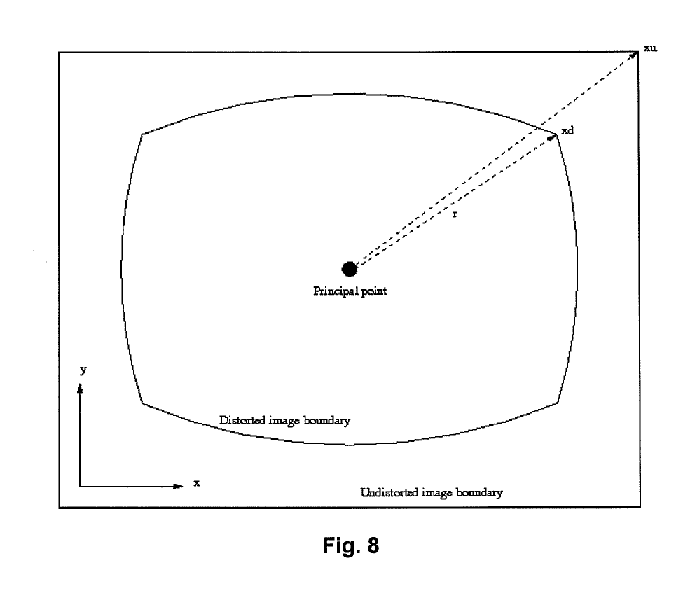

With the mean grid image having been smoothed, a lens distortion correction of the mean grid image is performed in order to correct for “pincushion” distortion in the mean grid image that is due to the physical shape of the lens of the imaging device 32. With reference to FIG. 8, lens distortion is often considered a combination of both radial and tangential effects. For short focal length applications such as in the case with imaging device 32, the radial effects dominate. Radial distortion occurs along the optical radius r.

The normalized, undistorted image coordinates (x′,y′) are calculated as shown in Equations 2 and 3, below:

x′=xₙ(1+K₁r²+K₂r⁴+K₃r⁶); (2)

y′=yₙ(1+K₁r²+K₂r⁴+K₃r⁶); (3)

where:

$$\begin{matrix}{x}_{n} = \frac{x - x 0}{f} and & ( 4 ) \\ {y}_{n} = \frac{y - {y}_{0}}{f} & ( 5 )\end{matrix}$$

are normalized, distorted image coordinates;

r²=(x−x₀)²+(y−y₀)²; (6)

(x₀, y₀) is the principal point;

f is the imaging device focal length; and

K₁, K₂ and K₃ are distortion coefficients.

The de-normalized and undistorted image coordinates (xᵤ, yᵤ) are calculated according to Equations 7 and 8, below:

xᵤ=fx′+x₀ (7)

yᵤ=fy′+y₀ (8)

The principal point (x0,y0), the focal length f and distortion coefficients K₁, K₂ and K₃ parameterize the effects of lens distortion for a given lens and imaging device sensor combination. The principal point, (x₀,y₀) is the origin for measuring the lens distortion as it is the center of symmetry for the lens distortion effect. As shown in FIG. 8, the undistorted image is larger than the distorted image. A known calibration process set out by Bouguet in the publication entitled “Camera Calibration Toolbox For Matlab”; 2007, http://www.vision.caltech.edu/bouguetj/calib_doc/index.html, the content of which is incorporated by reference herein in its entirety, may be employed to determine distortion coefficients K₁, K₂ and K₃.

It will be understood that the above distortion correction procedure is performed also during image processing when transforming images received from the imaging device 32 during use of the interactive input system 10.

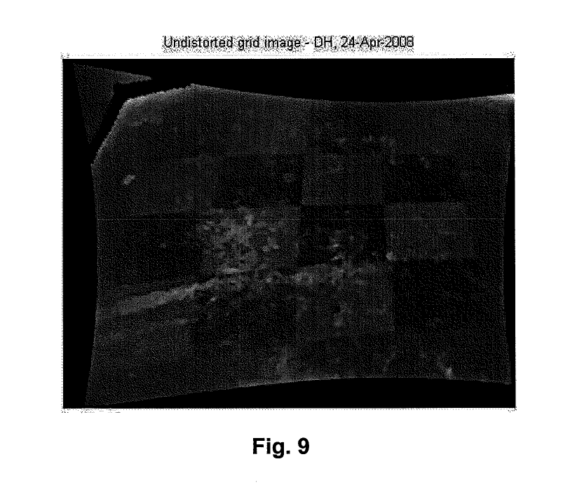

With the mean grid image having been corrected for lens distortion as shown in FIG. 9, an edge detection procedure is performed to detect grid lines in the mean grid image. Prior to performing edge detection, a sub-image of the undistorted mean grid image is created by cropping the corrected mean grid image to remove strong artifacts at the image edges, which can be seen also in FIG. 9, particularly at the top left and top right corners. The pixel intensity of the sub-image is then rescaled to the range of [0,1].

With the sub-image having been created and rescaled, Canny edge detection is then performed in order to emphasize image edges and reduce noise. During Canny edge detection, an edge image of the scaled sub-image is created by, along each coordinate, applying a centered difference, according to Equations 9 and 10, below:

$$\begin{matrix}\frac{\partial }{\partial x} I = \frac{{I}_{i , j + 1} - {I}_{i , j - 1}}{2} & ( 9 ) \\ \frac{\partial }{\partial y} I = \frac{{I}_{i + 1 , j} - {I}_{i - 1 , j}}{2} & ( 10 )\end{matrix}$$

where:

I represents the scaled sub-image; and

I_{i,j} is the pixel intensity of the scaled sub-image at position (i,j).

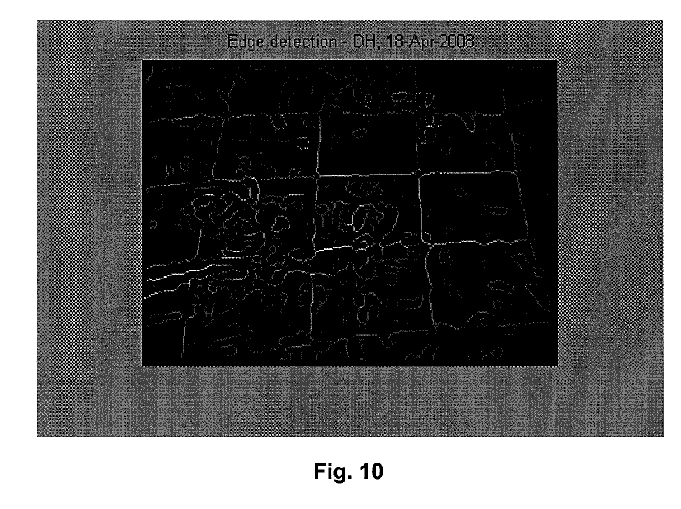

With Canny edge detection, non-maximum suppression is also performed in order to remove edge features that would not be associated with grid lines. Canny edge detection routines are described in the publication entitled “MATLAB Functions for Computer Vision and Image Analysis”, Kovesi, P. D., 2000; School of Computer Science & Software Engineering, The University of Western Australia, http://www.csse.uwa.edu.au/˜pk/research/matlabfnis/, the content of which is incorporated herein by reference in its entirety. FIG. 10 shows a resultant edge image that is used as the calibration image for subsequent processing.

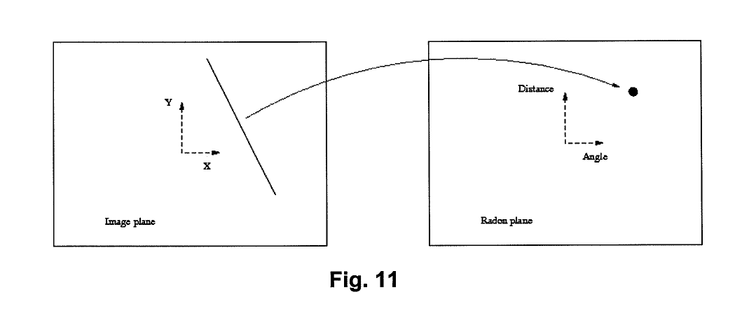

With the calibration image having been created, features are located in the calibration image (step 306). During feature location, prominent lines in the calibration are identified and their intersection points are determined in order to identify the intersection points as the located features. During identification of the prominent lines, the calibration image is transformed into the Radon plane using a Radon transform. The Radon transform converts a line in the image place to a point in the Radon plane, as shown in FIG. 11. Formally, the Radon transform is defined according to Equation 11, below:

$$R ( ρ , θ ) = \int \int F ( x , y ) δ ( ρ - x cos ( θ ) - y sin ( θ ) ) d x d y \qquad ( 11 )$$

where:

F(x,y) is the calibration image;

δ is the Dirac delta function; and

R(ρ,θ) is a point in the Radon plane that represents a line in the image plane for F(x,y) that is a distance ρ from the center of image F to the point in the line that is closes to the center of the image F, and at an angle θ with respect to the x-axis of the image plane.

The Radon transform evaluates each point in the calibration image to determine whether the point lies on each of a number of “test” lines x cos(θ)+y sin(θ)=p over a range of line angles and distances from the center of the calibration image, wherein the distances are measured to the line's closest point. As such, vertical lines correspond to an angle θ of zero (0) radians whereas horizontal lines correspond to an angle θ of π/2 radians.

The Radon transform may be evaluated numerically as a sum over the calibration image at discrete angles and distances. In this embodiment, the evaluation is conducted by approximating the Dirac delta function as a narrow Gaussian of width σ=1 pixel, and performing the sum according to Equation 12, below:

$${\sum }_{i = 1}^{{N}_{x}} ( {\sum }_{j = 1}^{{N}_{y}} F ( {x}_{i} , {y}_{j} ) {e}^{( - {( ρ - {x}_{i} cos ( θ ) - {y}_{j} sin ( θ ) )}^{2} )} ) \qquad ( 12 )$$

where:

the range of p is from −150 to 150 pixels; and

the range of 0 is from −2 to 2 radians.

The ranges set out above for ρ and θ enable isolation of the generally vertical and generally horizontal lines, thereby removing from consideration those lines that are unlikely to be grid lines and thereby reducing the amount of processing by the processing structure 20.

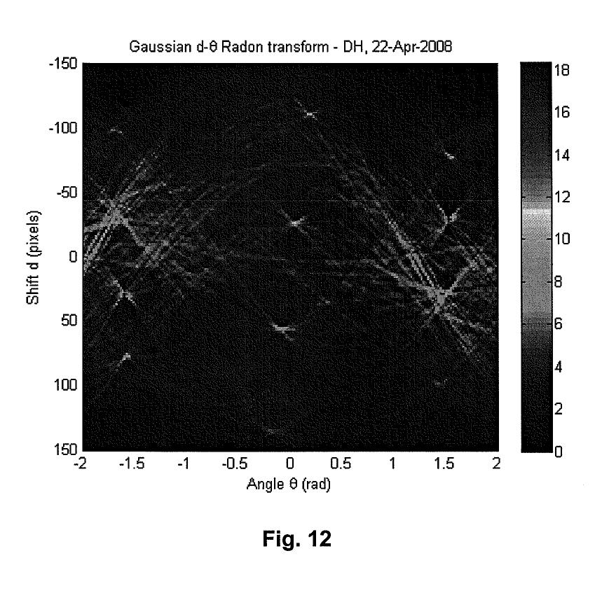

FIG. 12 is an image of an illustrative Radon transform image R(ρ, θ) of the calibration image of FIG. 10, with the angle θ on the horizontal axis ranging from −2 and 2 radians and the distance ρ on the vertical axis ranging from −150 to 150 pixels. As can be seen, there are four (4) maxima, or “peaks” at respective distances ρ at about the zero (0) radians position in the Radon transform image. Each of these four (4) maxima indicates a respective nearly vertical grid line in the calibration image. Similarly, the four (4) maxima at respective distances ρ at about the π/2 radians position in the Radon transform image indicate a respective, nearly horizontal grid line in the calibration image. The four (4) maxima at respective distances ρ at about the −π/2 radians position in the Radon transform image indicate the same horizontal lines as those mentioned above at the 1.5 radians position, having been considered by the Radon transform to have “flipped” vertically. The leftmost maxima are therefore redundant since the rightmost maxima suitably represent the nearly horizontal grid lines.

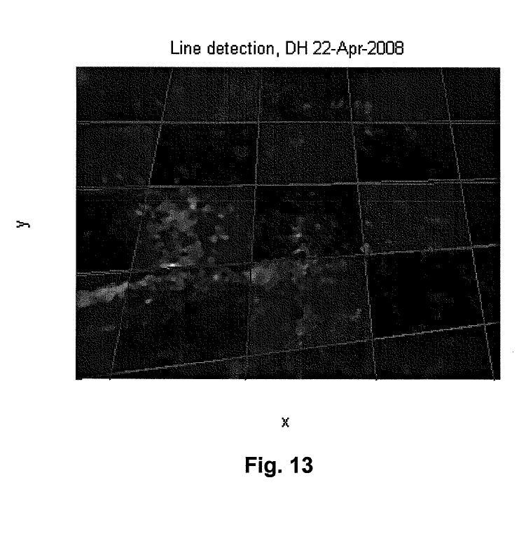

A clustering procedure is conducted to identify the maxima in the Radon transform image, and accordingly return a set of (ρ,θ) coordinates in the Radon transform image that represent grid lines in the calibration image. FIG. 13 shows the mean checkerboard image with the set of grid lines corresponding to the (ρ,θ) coordinates in the set returned by the clustering procedure having been superimposed on it. It can be seen that the grid lines correspond well with the checkerboard pattern.

With the grid lines having been determined, the intersection points of the grid lines are then calculated for use as feature points. During calculating of the intersection points, the vector product of each of the horizontal grid lines (ρ₁,θ₁) with each of the vertical grid lines (ρ₂,θ₂) is calculated as described in the publication entitled “Geometric Computation For Machine Vision”, Oxford University Press, Oxford; Kanatani, K.; 1993 the content of which is incorporated herein by reference in its entirety, and shown in general in Equation 13, below:

v=n×m (13)

where:

n=[cos(θ₁),sin(θ₁),ρ₁]^{T}; and

m=[cos(θ₂),sin(θ₂),ρ₂]^{T}.

The first two elements of each vector v are the coordinates of the intersection point of the lines n and m.

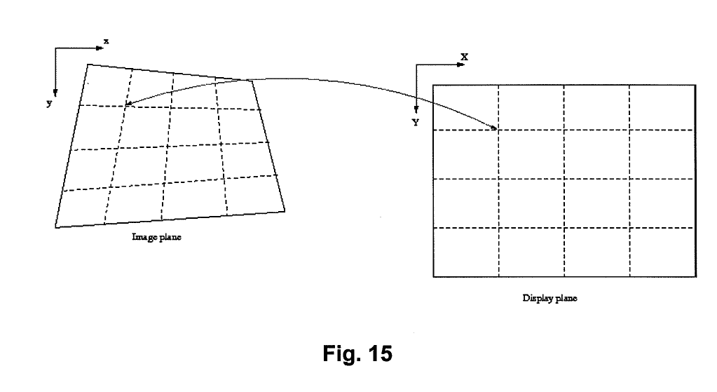

With the undistorted image coordinates of the intersection points having been located, a transformation between the touch panel display plane and the image plane is determined (step 308), as shown in the diagram of FIG. 15. The image plane is defined by the set of the determined intersection points, which are taken to correspond to known intersection points (X,Y) in the display plane. Because the scale of the display plane is arbitrary, each grid square is taken to have a side of unit length thereby to take each intersection points as being one unit away from the next intersection point. The aspect ratio of the display plane is applied to X and Y, as is necessary. As such, the aspect ratio of 4/3 may be used and both X and Y lie in the range [0,4].

During determination of the transformation, or “homography”, the intersection points in the image plane (x,y) are related to corresponding points (X,Y) in the display plane according to Equation 14, below:

$$[ \begin{matrix}x \\ y \\ 1\end{matrix} ] = [ \begin{matrix}{H}_{1 , 1} & {H}_{1 , 2} & {H}_{1 , 3} \\ {H}_{2 , 1} & {H}_{2 , 2} & {H}_{2 , 3} \\ {H}_{3 , 1} & {H}_{3 , 2} & {H}_{3 , 3}\end{matrix} ] [ \begin{matrix}X \\ Y \\ 1\end{matrix} ] \qquad ( 14 )$$

where:

H_{i,j} are the matrix elements of transformation matrix H encoding the position and orientation of the camera plane with respect to the display plane, to be determined.

The transformation is invertible if the matrix inverse of the homography exists; the homography is defined only up to an arbitrary scale factor. A least-squares estimation procedure is performed in order to compute the homography based on intersection points in the image plane having known corresponding intersection points in the display plane. A similar procedure is described in the publication entitled “Multiple View Geometry in Computer Vision”; Hartley, R. I., Zisserman, A. W., 2005; Second edition; Cambridge University Press, Cambridge, the content of which is incorporated herein by reference in its entirety. In general, the least-squares estimation procedure comprises an initial linear estimation of H, followed by a nonlinear refinement of H. The nonlinear refinement is performed using the Levenberg-Marquardt algorithm, otherwise known as the damped least-squares method, and can significantly improve the fit (measured as a decrease in the root-mean-square error of the fit).

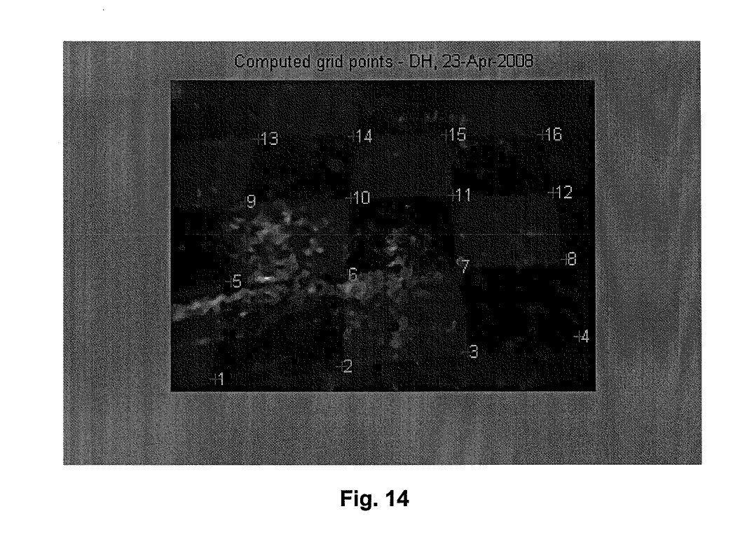

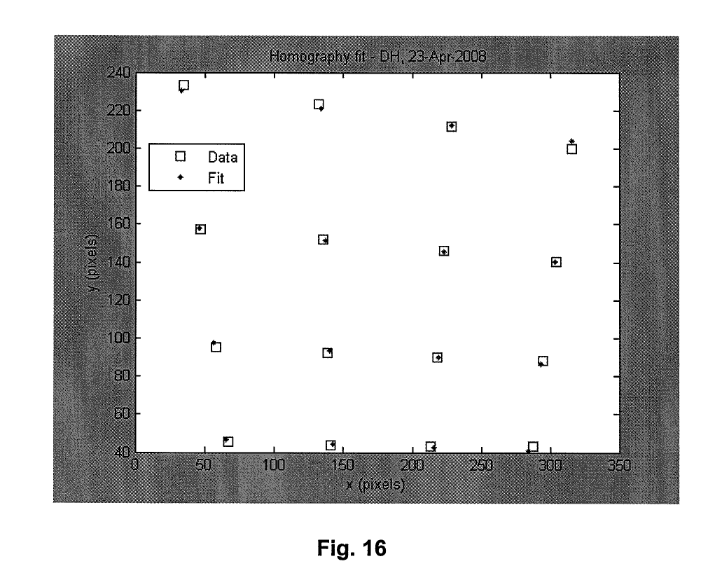

The fit of the above described transformation based on the intersection points of FIG. 14 is shown in FIG. 16. In this case, the final homography H transforming the display coordinates into image coordinates is shown in Equation 15, below:

$$H = \begin{matrix}24.8891 & - 3.2707 & 30.0737 \\ - 0.4856 & 22.4278 & 38.6608 \\ - 0.0051 & - 0.0151 & 0.6194\end{matrix} \qquad ( 15 )$$

In order to compute the inverse transformation (i.e. the transformation from image coordinates into display coordinates), the inverse of the matrix shown in Equation 15 is calculated, producing corresponding errors E due to inversion as shown in Equation 16, below:

$$E = \begin{matrix}0.2575 & 0.2949 & - 0.7348 \\ 0.3096 & 0.2902 & - 0.8180 \\ 0.0014 & 0.0014 & - 0.0043\end{matrix} \qquad ( 16 )$$

The calibration method described above is typically conducted when the interactive input system 10 is being configured. However, the calibration method may be conducted at the user's command, automatically executed from time to time and/or may be conducted during operation of the interactive input system 10. For example, the calibration checkerboard pattern could be interleaved with other presented images of application programs for short enough duration so as to perform calibration using the presented checkerboard/inverse checkerboard pattern without interrupting the user.

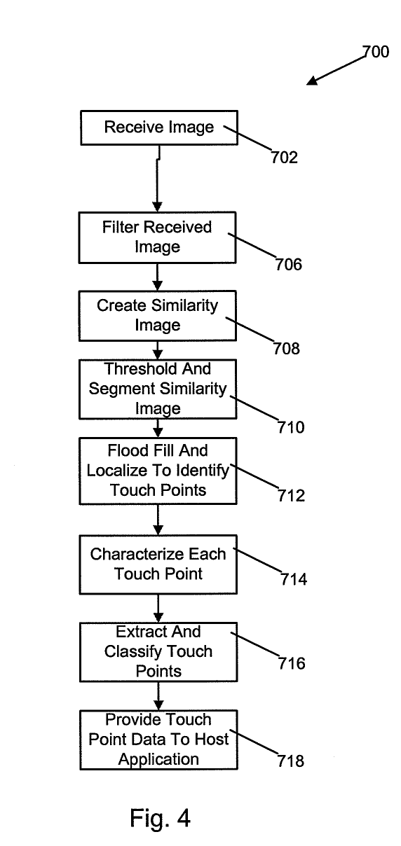

With the transformation from image coordinates to display coordinates having been determined, image processing during operation of the interactive input system 10 is performed in order to detect the coordinates and characteristics of one or more bright points in captured images corresponding to touch points. The coordinates of the touch points in the image plane are mapped to coordinates in the display plane based on the transformation and interpreted as ink or mouse events by application programs. FIG. 4 is a flowchart showing the steps performed during image processing in order to detect the coordinates and characteristics of the touch points.

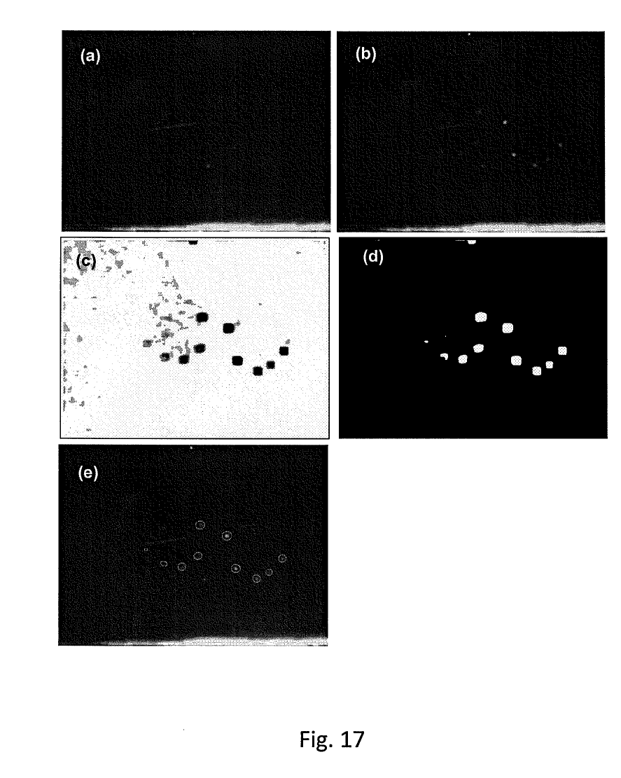

When each image captured by imaging device 32 is received (step 702), a Gaussian filter is applied to remove noise and generally smooth the image (step 706). An exemplary smoothed image I_{hg} is shown in FIG. 17(b). A similarity image Iₛ is then created using the smoothed image I_{hg} and an image I_{bq} having been captured of the background of the touch panel when there were no touch points (step 708), according to Equation 17 below, where sqrt( ) is the square root operation:

Iₛ=A/sqrt(B×C) (17)

where

A=I_{hg}×I_{bq};

B=I_{hg}×I_{hg}; and

C=I_{bq}×I_{bq}.

An exemplary background image I_{hg} is shown in FIG. 17(a), and an exemplary similarity image Iₛ is shown in FIG. 17(c).

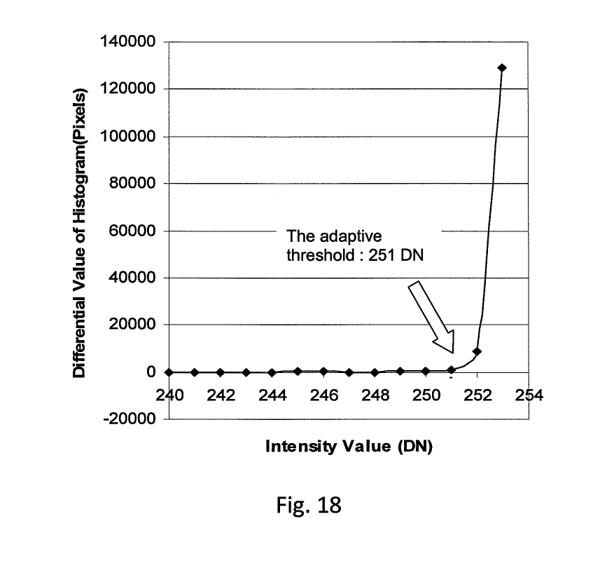

The similarity image Iₛ is adaptively thresholded and segmented in order to create a thresholded similarity image in which touch points in the thresholded similarity image are clearly distinguishable as white areas in an otherwise black image (step 710). It will be understood that, in fact, a touch point typically covers an area of several pixels in the images, and may therefore be referred to interchangeably as a touch area. During adaptive thresholding, an adaptive threshold is selected as the intensity value at which a large change in the number of pixels having that or a higher intensity value first manifests itself. This is determined by constructing a histogram for Iₛ representing pixel values at particular intensities, and creating a differential curve representing the differential values between the numbers of pixels at the particular intensities, as illustrated in FIG. 18 The adaptive threshold is selected as the intensity value (e.g., point A in FIG. 18) at which the differential curve transits from gradual changing (e.g., the curve on the left of point A in FIG. 18) to rapid changing (e.g., the curve on the right of point A in FIG. 18). Based on the adaptive threshold, the similarity image Iₛ is thresholded thereby to form a binary image, where pixels having intensity lower than the adaptive threshold are set to black, and pixels having intensity higher than the adaptive threshold are set to white. An exemplary binary image is shown in FIG. 17(d).

At step 712, a flood fill and localization procedure is then performed on the adaptively thresholded similarity image, in order to identify the touch points. During this procedure, white areas in the binary image are flood filled and labeled. Then, the average pixel intensity and the standard deviation in pixel intensity for each corresponding area in the smoothed image I_{hg} is determined, and used to define a local threshold for refining the bounds of the white area. By defining local thresholds for each touch point in this manner, two touch points that are physically close to each other can be successfully distinguished from each other as opposed to considered a single touch point.

At step 714, a principal component analysis (PCA) is then performed in order to characterize each identified touch point as an ellipse having an index number, a focal point, a major and minor axis, and an angle. The focal point coordinates are considered the coordinates of the center of the touch point, or the touch point location. An exemplary image having touch points characterized as respective ellipses is shown in FIG. 17(e). At step 716, feature extractions and classification is then performed to characterize each ellipse as, for example, a finger, a fist or a palm. With the touch points having been located and characterized, the touch point data is provided to the host application as input (step 718).

According to this embodiment, the processing structure 20 processes image data using both its central processing unit (CPU) and a graphics processing unit (GPU). As will be understood, a GPU is structured so as to be very efficient at parallel processing operations and is therefore well-suited to quickly processing image data. In this embodiment, the CPU receives the captured images from imaging device 32, and provides the captured images to the graphics processing unit (GPU). The GPU performs the filtering, similarity image creation, thresholding, flood filling and localization. The processed images are provided by the GPU back to the CPU for the PCA and characterizing. The CPU then provides the touch point data to the host application for use as ink and/or mouse command input data.

Upon receipt by the host application, the touch point data captured in the image coordinate system undergoes a transformation to account for the effects of lens distortion caused by the imaging device, and a transformation of the undistorted touch point data into the display coordinate system. The lens distortion transformation is the same as that described above with reference to the calibration method, and the transformation of the undistorted touch point data into the display coordinate system is a mapping based on the transformation determined during calibration. The host application then tracks each touch point, and handles continuity processing between image frames. More particularly, the host application receives touch point data and based on the touch point data determines whether to register a new touch point, modify an existing touch point, or cancel/delete an existing touch point. Thus, the host application registers a Contact Down event representing a new touch point when it receives touch point data that is not related to an existing touch point, and accords the new touch point a unique identifier. Touch point data may be considered unrelated to an existing touch point if it characterizes a touch point that is a threshold distance away from an existing touch point, for example. The host application registers a Contact Move event representing movement of the touch point when it receives touch point data that is related to an existing pointer, for example by being within a threshold distance of, or overlapping an existing touch point, but having a different focal point. The host application registers a Contact Up event representing removal of the touch point from the surface of the touch panel 14 when touch point data that can be associated with an existing touch point ceases to be received from subsequent images. The Contact Down, Contact Move and Contact Up events are passed to respective elements of the user interface such as graphical objects, widgets, or the background/canvas, based on the element with which the touch point is currently associated, and/or the touch point's current position.

The method and system described above for calibrating an interactive input system, and the method and system described above for determining touch points may be embodied in one or more software applications comprising computer executable instructions executed by the processing structure 20. The software application(s) may comprise program modules including routines, programs, object components, data structures etc. and may be embodied as computer readable program code stored on a computer readable medium. The computer readable medium is any data storage device that can store data, which can thereafter be read by a processing structure 20. Examples of computer readable media include for example read-only memory, random-access memory, CD-ROMs, magnetic tape and optical data storage devices. The computer readable program code can also be distributed over a network including coupled computer systems so that the computer readable program code is stored and executed in a distributed fashion.

While the above has been set out with reference to an embodiment, it will be understood that alternative embodiments that fall within the purpose of the invention set forth herein are possible.

For example, while individual touch points have been described above as been characterized as ellipses, it will be understood that touch points may be characterized as rectangles, squares, or other shapes. It may be that all touch points in a given session are characterized as having the same shape, such as a square, with different sizes and orientations, or that different simultaneous touch points be characterized as having different shapes depending upon the shape of the pointer itself. By supporting characterizing of different shapes, different actions may be taken for different shapes of pointers, increasing the ways by which applications may be controlled.

While embodiments described above employ anisotropic diffusion during the calibration method to smooth the mean grid image prior to lens distortion correction, other smoothing techniques may be used as desired, such as for example applying a median filter of 3×3 pixels or greater.

While embodiments described above during the image processing perform lens distortion correction and image coordinate to display coordinate transformation of touch points, according to an alternative embodiment, the lens distortion correction and transformation is performed on the received images, such that image processing is performed on undistorted and transformed images to locate touch points that do not need further transformation. In such an implementation, distortion correction and transformation will have been accordingly performed on the background image I_{bg}.

Although embodiments have been described with reference to the drawings, those of skill in the art will appreciate that variations and modifications may be made without departing from the spirit and scope thereof as defined by the appended claims.

What is claimed is:

1. A method of calibrating an interactive input system, comprising:
receiving images of a calibration video presented on a touch panel of the interactive input system;
creating a calibration image based on the received images;
locating features in the calibration image; and
determining a transformation between the touch panel and the received images based on the located features and corresponding features in the calibration video.

2. The method of claim 1, wherein the calibration video comprises a set of frames with a checkerboard pattern and a set of frames with an inverse checkerboard pattern.

3. The method of claim 2, wherein creating a calibration image comprises:
creating a mean checkerboard image based on received images of the checkerboard pattern;
creating a mean inverse checkerboard image based on received images of the inverse checkerboard pattern; and
creating a difference image as the difference between the mean checkerboard image and the mean inverse checkerboard image.

4. The method of claim 3, wherein received images of the checkerboard pattern are distinguished from received images of the inverse checkerboard pattern based on the pixel intensity at a selected location in the received images.

5. The method of claim 4, further comprising selecting received images for creating the mean and mean inverse checkerboard images based on the pixel intensity at the selected location in respective received images being above or below an intensity range.

6. The method of claim 3, further comprising thresholding pixels in the selected received images as either black or white pixels.

7. The method of claim 3, wherein the located features are intersection points of lines common to the checkerboard and inverse checkerboard patterns.

8. The method of claim 7, wherein the lines are identified as peaks in a Radon transform of the calibration image.

9. The method of claim 8, wherein the intersection points are identified based on vector products of the identified lines.

10. The method of claim 1, wherein creating a calibration image comprises:
creating a mean calibration image based on the received images; and
performing a smoothing, edge-preserving procedure to remove noise from the mean calibration image.

11. The method of claim 10, wherein the smoothing, edge-preserving procedure is an anisotropic diffusion procedure.

12. The method of claim 10, wherein the smoothing, edge-preserving procedure is a median filtering.

13. The method of claim 10, wherein creating a calibration image further comprises performing lens distortion correction on the mean calibration image.

14. The method of claim 13, wherein the lens distortion correction is based on predetermined lens distortion parameters.

15. The method of claim 11, wherein creating a calibration image comprises creating an edge image.

16. The method of claim 15, wherein creating the calibration image further comprises filtering the edge image to preserve prominent edges.

17. The method of claim 16, wherein the filtering comprises performing non-maximum suppression to the edge image.

18. The method of claim 3, further comprising cropping the difference image.

19. An interactive input system comprising a touch panel and processing structure executing a calibration method, said calibration method determining a transformation between the touch panel and an imaging plane based on known features in a calibration video presented on the touch panel and features located in a calibration image created based on received images of the calibration video.

20. A computer readable medium embodying a computer program for calibrating an interactive input device, the computer program comprising:
computer program code receiving images of a calibration video presented on a touch panel of the interactive input system;
computer program code creating a calibration image based on the received images;
computer program code locating features in the calibration image; and
computer program code determining a transformation between the touch panel and the received images based on the located features and corresponding features in the calibration video.

21. A method for determining one or more touch points in a captured image of a touch panel in an interactive input system, comprising:
creating a similarity image based on the captured image and an image of the touch panel without any touch points;
creating a thresholded image by thresholding the similarity image based on an adaptive threshold;
identifying one or more touch points as areas in the thresholded image;
refining the bounds of the one or more touch points based on pixel intensities in corresponding areas in the similarity image.

23. The method of claim 21, wherein the similarity image is smoothed prior to creating the thresholded image.

23. The method of claim 21, further comprising characterizing each touch point as an ellipse having center coordinates.

24. The method of claim 23, further comprising mapping each touch point center coordinate to a display coordinate.

25. The method of claim 21, further comprising prior to creating a similarity image, transforming the captured image and the background image to a display coordinate system and to correct for lens distortion.

26. An interactive input system comprising a touch panel and processing structure executing a touch point determination method, said touch point determination method determining one or more touch points in a captured image of the touch panel as areas identified in a thresholded similarity image refined using pixel intensities in corresponding areas in the similarity image.

27. A computer readable medium embodying a computer program for determining one or more touch points in a captured image of a touch panel in an interactive input system, the computer program comprising:
computer program code creating a similarity image based on the captured image and an image of the touch panel without any touch points;
computer program code creating a thresholded image by thresholding the similarity image based on an adaptive threshold;
computer program code identifying one or more touch points as areas in the thresholded image;
computer program code refining the bounds of the one or more touch points based on pixel intensities in corresponding areas in the similarity image.
